(19) United States
(12) Patent Application Publication
(10) Pub. No.: US 2019/0188685 A1
(43) Pub. Date: Jun. 20, 2019

(54) CENTRALIZED TRANSACTION LIMIT MANAGEMENT IN PAYMENT ACCOUNT SYSTEM

(71) Applicant: MasterCard International Incorporated, Purchase, NY (US)

(72) Inventors: John Gaitanos, London (GB); Alan Johnson, Salcott (GB); Mehdi Collinge, Mont-Sainte-Aldegonde (BE)

(21) Appl. No.: 15/846,470

(22) Filed: Dec. 19, 2017

(51) Int. Cl. G06Q 20/34; G06Q 20/40; G06Q 20/36; G06Q 20/20

(52) U.S. Cl. CPC G06Q 20/341; G06Q 20/4012; G06Q 20/12; G06Q 20/36; G06Q 20/206; G06Q 20/4014

(57) ABSTRACT

A transaction request is received. The transaction request is for a transaction to charge a payment account managed by a payment entity. It is detected that the transaction request exceeds a transaction limit that is applicable to the payment account. A message is transmitted to the payment entity to indicate that the transaction request exceeds the transaction limit.

### BACKGROUND

FIG. 1 is a block diagram that illustrates a conventional payment system 100.

The system 100 includes a payment device 102 (which may in some situations be a payment-enabled mobile device that stores a payment card account number and runs a payment applet; other form factors for the payment device, such as a fob, are also possible; also card-shaped payment devices, including payment IC cards and magnetic stripe cards are widely used). The system 100 further includes a reader component 104 associated with a POS (point of sale) terminal 106. In some known manner the reader component 104 is capable of reading the payment card account number and other information from the payment device 102. (Some usages include the term “point of interaction” to include both the point of sale at a retail store, plus card acceptance terminals or the like at premises of service providers, transit system entrance gate terminals, etc.)

The reader component 104 and the POS terminal 106 may be located at the premises of a retail store and operated by a sales associate of the retailer for the purpose of processing retail transactions. The payment device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate to receive an authorization request for the transaction from the POS terminal 106. The acquirer computer 108 may route the authorization request via a payment network 110 (sometimes also referred to as a “card network”) to the server computer 112 operated by the issuer of a payment account that is associated with the payment device 102. An authorization response generated by the payment account issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment devices for initiating payment transactions by presenting an associated payment account number to the reader component of a POS terminal.

A typical payment system like that shown in FIG. 1 may also handle other types of transactions, including online shopping transactions in which the purchaser submits a payment account number and related data to an e-commerce website-hosting computer (not shown in FIG. 1). In such situations, the e-commerce computer may play a role similar to that of the POS terminal 106 in terms of initiating a transaction authorization request message for routing to the issuer 112 via the acquirer 108 (or a payment processor—not separately shown—acting for the acquirer) and the payment network 112.

In many payment account system transactions, security concerns are addressed by requiring the user to authenticate himself/herself. For example, the user may be required to enter a PIN (personal identification number) into a payment-enabled mobile device to enable the device to conduct a current transaction. As an alternative to PIN entry, some payment-enabled mobile devices include a biometric user authentication capability, such as a fingerprint scanner.

Transaction practices as mandated by payment account issuers often reflect a balance between user convenience and transaction security. Consequently, some issuers—in order to promote convenience—may wish to permit an account holder/user to perform a limited number of low-value transactions and/or a limited cumulative monetary total of transactions before requiring user authentication to occur. To facilitate this trade-off, one or more transaction or monetary amount limits must be established and a transaction counter and/or monetary amount accumulator must be maintained and updated to reflect ongoing transactions. However, provision of data processing resources to perform these functions may be burdensome on an account issuer. At the same time, assigning transaction/monetary amount limit enforcement to wallet applications in user devices may also present inconveniences and may not allow for the type of flexibility in application of limit enforcement that an account issuer may desire.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a high-level block diagram that illustrates a payment system provided according to aspects of the present disclosure.

FIG. 3 is a block diagram that illustrates a computer system that may perform a role in the system of FIG. 2.

FIG. 4 is a flow chart that illustrates a process that may be performed in the system of FIG. 2 according to aspects of the present disclosure.

### DETAILED DESCRIPTION

In general, and for the purpose of introducing concepts of embodiments of the present disclosure, transaction limits or the like are managed and monitored by computing resources functionally located at the center of a payment system. Limit definitions and counters/accumulators are maintained, and payment system transactions are monitored at the central data processing facility. When a transaction is determined to exceed an applicable limit, the account issuer is notified of the crossing of the limit and may determine that the transaction may be declined and/or user authentication may be required.

In other embodiments, the notification may be provided to another payment entity, such as a digital wallet that stores account data for a payment account that is subject to the limit. The digital wallet may be provided by the account issuer or by a wallet service provider, for example.

In some alternative embodiments, the central data processing facility does not itself determine that a limit has been exceeded. Rather, in these alternative embodiments, the central data processing facility may extract and pre-process transaction data and may then transmit the necessary data to the account issuer or other payment entity, which in turn makes a determination as to whether an applicable limit has been exceeded.

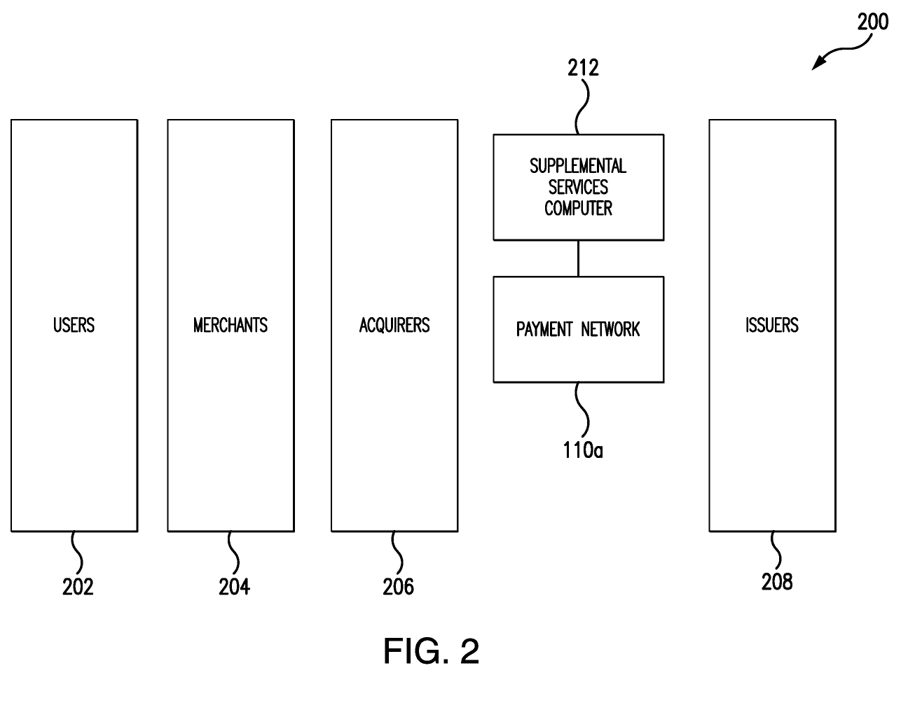

FIG. 2 is a high-level block diagram that illustrates a payment system 200 provided according to aspects of the present disclosure.

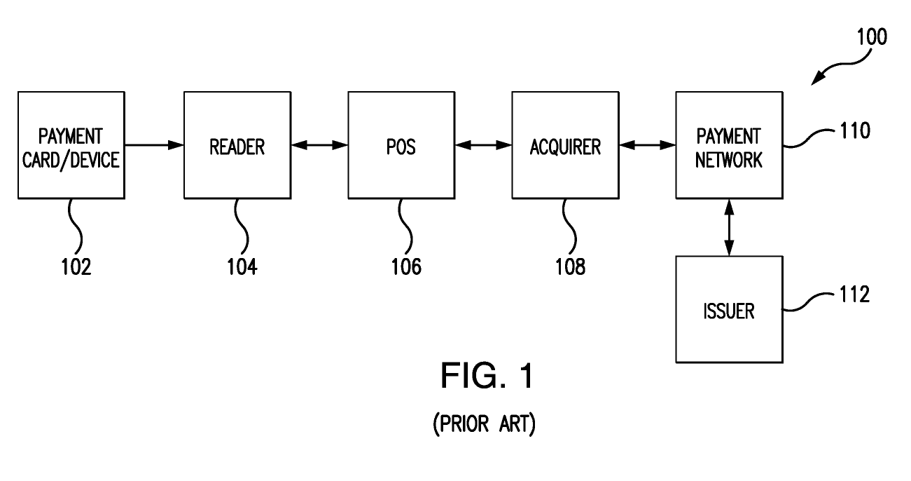

Block 202 in FIG. 2 represents users of the payment system 200, who may carry and initiate transactions with payment devices such as the card/device 102 shown in FIG. 1.

Block 204 represent merchants who participate in the payment system. It should be understood from the above discussion of FIG. 1 that the merchants may each operate one or more items of POS equipment (such as the reader 104/POS device 106 shown in FIG. 1). In addition, or alternatively, the merchants may sponsor e-commerce servers to facilitate online shopping transactions.

Block 206 represents acquirers such as the acquirer 108 shown in FIG. 1.

Block 208 represents account issuers such as the issuer 112 shown in FIG. 1.

Block 110a represents a payment network, which may resemble in many respects the payment network 110 shown in FIG. 1.

Block 212 represents a supplemental services computer, which may be associated with, and which may operate in functional cooperation with, the payment network 110a. Details of the supplemental services computer 212 will be described below. In brief, and among other functions that may be performed by the supplemental services computer 212, the supplemental services computer 212 may maintain, manage and track compliance with transaction/monetary amount limits as prescribed by the account issuers for individual payment accounts issued to the system users/account holders. It will be understood that the supplemental services computer 212 is located remotely from the point of sale and from the users' payment devices (not shown in FIG. 2).

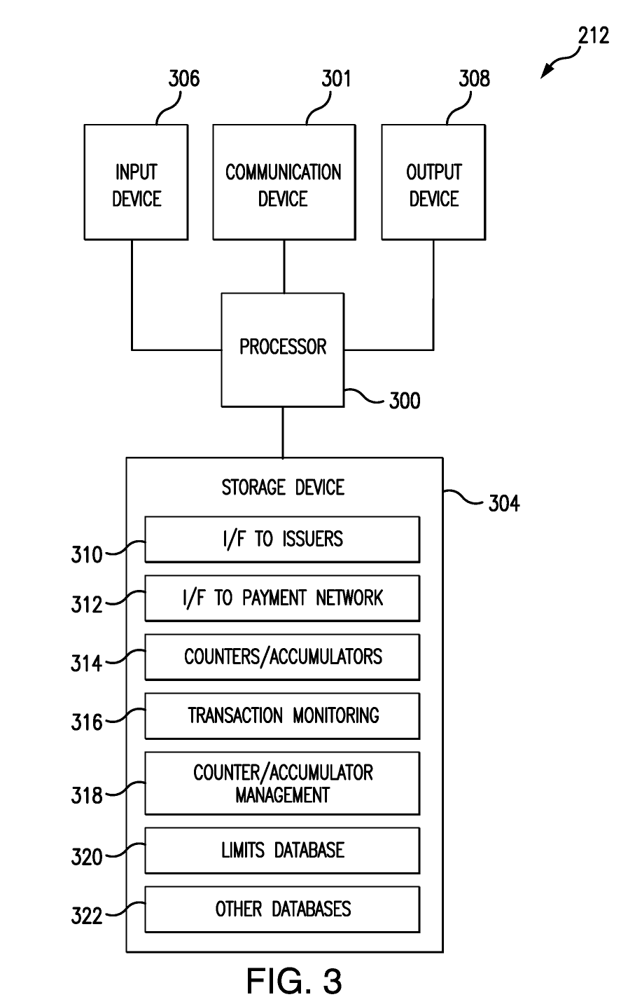

FIG. 3 is a block diagram that illustrates an embodiment of the supplemental services computer 212 shown in FIG. 2.

Referring now to FIG. 3, the supplemental services computer 212 may, in its hardware aspects, resemble a typical server computer and/or mainframe computer, but may be controlled by software to cause it to function as described herein. For example, the supplemental services computer 212 may be constituted by commercially available server computer hardware and/or by cloud-based computing resources.

The supplemental services computer 212 may include a computer processor 300 operatively coupled to a communication device 301, a storage device 304, an input device 306 and an output device 308. The communications device 301, the storage device 304, the input device 306 and the output device 308 may all be in communication with the processor 300.

The computer processor 300 may be constituted by one or more conventional processors. Processor 300 operates to execute processor-executable steps, contained in program instructions described below, so as to control the supplemental services computer 212 to provide desired functionality.

Communication device 301 may be used to facilitate communication with, for example, other devices (such as one or more computers operated by the payment network 110a and/or one or more computers operated by account issuers 208). For example (and continuing to refer to FIG. 3), communication device 301 may comprise numerous communication ports (not separately shown), to allow the supplemental services computer 212 to communicate simultaneously with a number of other computers and other devices, including communications as required to simultaneously handle numerous interactions with account issuers and numerous exchanges of data with the payment network 110a.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the supplemental services computer 212, executed by the processor 300 to cause the supplemental services computer 212 to function as described herein.

The programs may include one or more conventional operating systems (not shown) that control the processor 300 so as to manage and coordinate activities and sharing of resources in the supplemental services computer 212, and to serve as a host for application programs (described below) that run on the supplemental services computer 212.

The programs stored in the storage device 304 may also include a software communication interface 310 for facilitating communications with the account issuers 208.

The storage device 304 may also store a software communication interface 312 for facilitating communications with the payment network 110a.

Still further, the storage device 304 may store counters and/or accumulators (block 314) that the supplemental services computer 212 uses to monitor compliance with transaction/monetary limits prescribed by account issuers 208 for the payment accounts issued by the account issuers 208 to the users/account holders 202.

Continuing to refer to FIG. 3, the storage device 304 may also store a transaction monitoring application program 316. The transaction monitoring application program 316 may control the processor 300 to enable the supplemental services computer 212 to monitor transactions handled (or proposed to be handled) in the payment system 200 to determine whether execution of some or each transaction may result in exceeding a limit that is applicable to the payment account proposed to be used in the transaction.

Again continuing to refer to FIG. 3, the storage device 304 may additionally store a counter/accumulator management application program 318. The counter/accumulator management application program 318 may be responsive to the transaction monitoring application program 316 to increment, update or reset counters and/or accumulators as appropriate in view of transaction data received by the supplemental services computer 212 via the transaction monitoring application program 316.

The storage device 304 may also store, and the supplemental services computer 212 may also execute, other programs, which are not shown. For example, such programs may include a reporting application, which may respond to requests from system administrators for reports on the activities performed by the supplemental services computer 212. The other programs may also include, e.g., one or more data communication programs, database management software, device drivers, etc.

Further, the storage device 304 may store a limits database 320. The limits database may store transaction/monetary amount limits made applicable to payment accounts by the issuers of the payment accounts. The data for the limits database 320 may be communicated to the supplemental services computer 212 by the account issuers 208. In some embodiments, the limits data may be indexed by payment account identifier (i.e., primary account number or “PAN”, payment token or alternate account descriptor). As is known to those who are skilled in the art, a payment token is a multi-digit number or other character string that is used in place of a PAN during a portion of a payment account transaction process.

The storage device 304 may also store one or more other databases 322 required for operation of the supplemental services computer 212.

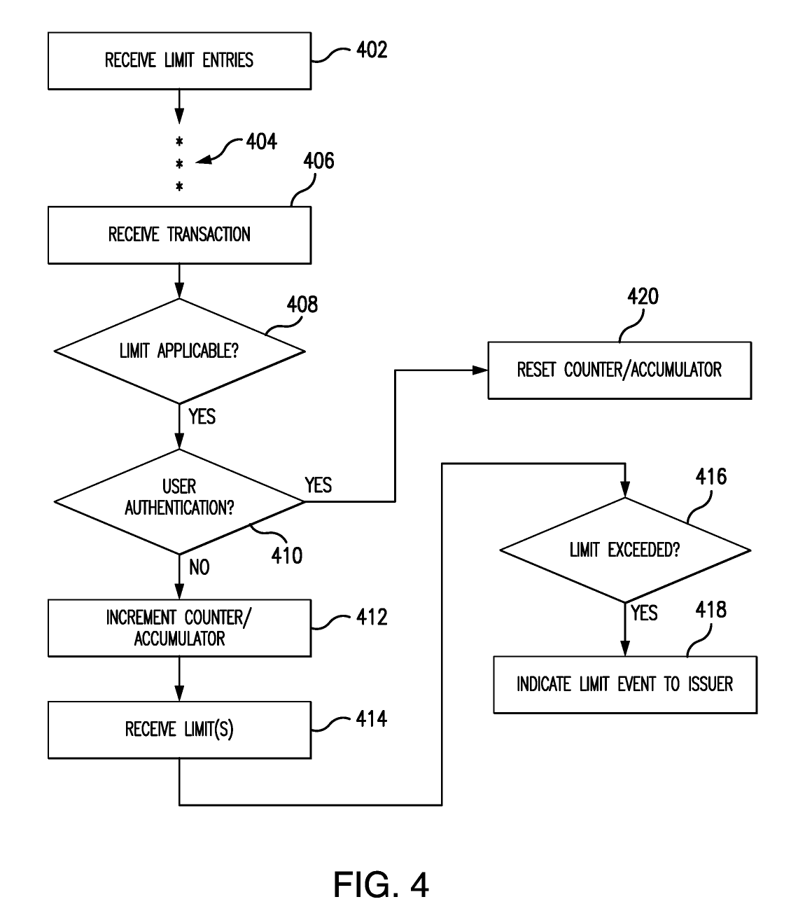

FIG. 4 is a flow chart that illustrates a process that may be performed in the payment system 200, and particularly in the supplemental services computer 212, according to aspects of the present disclosure.

Block 402 in FIG. 4 is indicative of the supplemental services computer 212 receiving data entries from account issuers to establish, modify or remove transaction and/or monetary account limits on the use of payment accounts issued by the account issuers. As indicated by the ellipsis 404, the receipt of these limit data entries is logically prior, and temporally may occur a considerable period of time prior, to subsequent limit-related processing by the supplemental services computer 212. However, the account issuers may transmit (to the supplemental services computer 212) data messages relating to account usage limits on an ongoing basis as the issuers add new accounts, provision new payment tokens, modify limit practices or policies, change desired limits for a given account, or decommission accounts or tokens. Accordingly, the receipt of account limit data entries as represented by block 402 may be an ongoing process for the supplemental services computer 212, occurring frequently in real time and/or in batch downloads from account issuers. It will be appreciated that the supplemental services computer 212 may store the limit data it receives from the account issuer.

There will now be discussion of various types of account use limits that may be applied by account issuers and monitored/administered by the supplemental services computer 212.

According to one simple example, for a particular payment account identifier, there may be a limit of five low-value transactions permitted without user authentication, before again requiring that user authentication be performed. If the limit in this case is applicable to a payment token, that token may be the one that has been provisioned to the account holder's payment-enabled mobile device. To implement this five-transaction limit, the supplemental services computer 212 may establish, maintain and monitor a transaction counter. In other related examples, the number of low-value transactions allowed without user authentication may be a number other than five. The definition of a “low-value” transaction may be tied to a monetary amount threshold as set by the account issuer.

According to another example, for a particular payment account identifier, after a successful user authentication has occurred, a cumulative total of not to exceed $200 worth of transactions may be performed before requiring the next user authentication to be performed. For this cumulative monetary amount limit, the supplemental services computer 212 may establish, maintain and monitor a monetary amount accumulator. Of course, a monetary amount limit other than $200 may be utilized.

According to still another example, there may be a per transaction limit of $50. For transactions of less than that amount, no user authentication is required. For transaction in that amount or higher, successful user authentication is required. For a limit of this type, the supplemental services computer 212 need not establish or monitor a counter or accumulator.

In another example, two types of limits (e.g., number of transactions and cumulative total of transaction amounts) may be applicable to the same payment account identifier. To give a more specific example of this kind, the definition of “low-value transaction” may be less than $50, and five such transactions may be permitted before the next successful user authentication, but further subject to a cumulative monetary amount limit of $100 before the next successful user authentication. For a set of limits like this, the supplemental services computer 212 may establish, manage and monitor both a transaction counter and a monetary amount accumulator. In other variations, a different number of transactions and/or a different cumulative monetary amount may be used to define applicable limits.

From the above, at least, those who are skilled in the art will recognize that other examples of limits—as to number of transactions or monetary amount—may be developed consistent with the teachings of this disclosure.

Referring again to FIG. 4, at block 406 the supplemental services computer 212 receives data concerning a currently proposed transaction to be performed in the payment system 200. (Among other possibilities, the transaction may be at a point of sale in a retail store, or may be an e-commerce transaction.) The supplemental services computer 212 may receive the transaction data from the payment network 110a. The transaction data may be abstracted from a transaction authorization request message that has been routed to the payment network 110a from the point of sale. The transaction data may include the payment account identifier, the transaction amount, and an indication as to whether or not a successful user authentication was performed in connection with the transaction. (In some embodiments, after the payment network 110a provides the transaction data to the supplemental services computer 212, the payment network 110a may cause the transaction authorization request message to be held at the payment network 110a until a result is obtained from the transaction limit monitoring processing by the supplemental services computer 212 as described herein with reference to FIG. 4.)

Continuing to refer to FIG. 4, a decision block 408 may follow block 406 in the process illustrated in FIG. 4. At decision block 408, the supplemental services computer 212 may determine whether there is a transaction/monetary amount limit that is applicable to the transaction/payment account for which the supplemental services computer 212 received data at 406. If so, then decision block 410 may follow decision block 408.

At decision block 410, the supplemental services computer 212 may determine whether the transaction data received at 406 indicated that a successful user authentication was performed in connection with the current transaction. If not, then block 412 may follow decision block 410.

At block 412, the supplemental services computer 212 performs at least one of (a) incrementing the transaction counter for the payment account identifier in question and (b) increasing the accumulator value (for the payment account identifier in question) by the monetary amount of the current transaction. (For purposes of this disclosure and the appended claims, the latter action will be considered “incrementing” the accumulator.) It will be appreciated that the former action will occur only if a counter is being maintained and managed for the payment account identifier in question, and the latter action will occur only if an accumulator is being managed and maintained for the payment account identifier in question.

Block 414 may follow block 412 in the process illustrated in FIG. 4. At block 414, the supplemental services computer 212 may retrieve previously stored limit definition data for the payment account identifier in question in order to compare the current counter value/accumulator value with the transaction/monetary amount limit(s) indicated by the limit definition data.

Decision block 416 may follow block 414 in the process illustrated in FIG. 4. At decision block 416, the supplemental services computer 212 may determine whether the limit(s) indicated by the retrieved limit definition data have(has) been exceeded. This determination may be made by comparing the current counter/accumulator value with the indicated limit(s).

If a positive determination is made at decision block 416 (i.e., if the supplemental services computer 212 determines that an applicable limit has been exceeded), then block 418 may follow decision block 416. At block 418, the supplemental services computer 212 may provide an indication to the payment network 110a that the proposed transaction would result in exceeding an applicable limit for the payment account identifier in question. In some embodiments, this indication may include details about the exceeded-limit event, including for example the indicated limit value and the counter/accumulator value(s) that would result if the transaction is authorized. The payment network 110a then may insert the indication and/or data therefrom in the transaction authorization request message and then may route the transaction authorization request message to the account issuer. In some embodiments, it may be up to the account issuer to select among further steps such as declining the transaction, requiring a user authentication to be performed or authorizing the transaction without user authentication notwithstanding the exceeded-limit event.

Referring again to decision block 408 in FIG. 4, according to a process branch that is not explicitly shown, if no limit is applicable to the payment account identifier in question, then the supplemental services computer 212 may provide a “null” indication (i.e., an indication of “no exceeded-limit event”) to the payment network 110a, which may then proceed to route the transaction authorization request message to the account issuer.

Referring again to decision block 416 in FIG. 4, according to a process branch not explicitly shown, if it is determined at decision block 416 that no limit applicable to the payment account identifier was exceeded, then in this case as well the supplemental services computer 212 may provide a “null” indication to the payment network 110a, which may then route the transaction authorization request message to the account issuer.

Referring again to decision block 410 in FIG. 4, if a positive determination is made at this point (i.e., if the supplemental services computer 212 determines that the transaction data indicates that there was a successful user authentication in connection with the current transaction), then block 420 may follow decision block 410.

At block 420, the supplemental services computer 212 may reset (i.e., zero-out) the relevant counter and/or accumulator. In this type of case, it may be that (in view of the indication of a successful user authentication) the payment network 110a did not hold the transaction authorization request message, so that no “null” indication may be required from the supplemental services computer 212 to the payment network 110a.

In a case where the only applicable limit is a monetary limit for individual transactions, then block 412 relating to incrementing a counter/accumulator may be omitted.

With administration and monitoring of transaction/monetary limits handled via computing resources associated with the payment network level of the payment system, the burden of operating and enforcing such limits may be significantly reduced for account issuers. With the resulting efficiencies, account issuers may more easily provide a suitable balance between necessary transaction security—on the one hand—and convenience for account holders (e.g., particularly for small transactions)—on the other hand.

Another possible advantage of the system of FIGS. 2-4 is that counters are not stored at the wallet/user device level, where the counters would possibly be vulnerable to attack by hackers or other wrongdoers.

The administration of limits as described herein may be applied to situations in which two or more payment tokens are issued to correspond to a single payment account. In some embodiments, different limits may be applicable to each token that corresponds to the payment account.

In example embodiments described above, an account issuer was notified that a transaction exceeds an applicable limit. In alternative embodiments, however, an entity other than an account issuer may be notified. For example, a digital wallet with which the payment account is associated may be notified. The digital wallet may have been provided by the account issuer or by a wallet service provider, for example. The term “payment entity” will now be introduced. As used herein and in the appended claims, the term “payment entity” refers to an account issuer or a digital wallet. The term “managing a payment account” will now be introduced. As used herein and in the appended claims, the term “managing a payment account” refers to issuing or maintaining or having an association with the payment account.

In example embodiments described above, a central supplemental services computer provides a notification concerning an exceeded limit to a payment entity that manages a payment account to which the limit is applicable. However, in alternative embodiments, the supplemental services computer may not itself detect the exceeding of the limit, but may instead extract and pre-process data regarding a payment account transaction, and may supply the resulting data to the relevant payment entity to enable the payment entity to determine whether the limit has been exceeded (and if so, to determine what if any steps to take). The data pre-processing by the supplemental services computer may include (a) extracting transaction data from the payment account transaction request; (b) retrieving a current value from at least one relevant counter or accumulator maintained by the supplemental services computer; and (c) retrieving an applicable limit for the payment account. The supplemental services computer may forward all of this data to the appropriate payment entity.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “transaction limit” encompasses either or both of limits defined in terms of number of transactions and limits defined in terms of monetary amounts—either cumulative or related to an individual transaction.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card or an account accessible through a payment card system via an ACH (automated clearing house) transaction. The terms “payment card system account” and “payment card account” and “payment account” are used interchangeably herein. The terms “payment card account number” or “account indicator” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a transaction request, the transaction request for a transaction to charge a payment account managed by a payment entity;
detecting that the transaction request exceeds a transaction limit applicable to the payment account; and
transmitting a message to the payment entity to indicate that the transaction request exceeds the transaction limit.

2. The method of claim 1, wherein the transaction limit is defined as a monetary amount.

3. The method of claim 2, wherein the monetary amount is a cumulative amount.

4. The method of claim 2, wherein the monetary amount is a single-transaction amount.

5. The method of claim 1, wherein the transaction limit is defined as a number of transactions.

6. The method of claim 1, wherein the transaction limit applies to all transactions that use any one of a plurality of payment tokens, all of the payment tokens corresponding to said payment account.

7. The method of claim 1, further comprising, prior to said receiving step, accumulating at least one of (a) a transaction count relevant to said transaction limit; and (b) transaction amounts relevant to said transaction limit.

8. An apparatus comprising:
a processor; and
a memory in communication with the processor, the memory storing program instructions, the processor operative with the program instructions to perform functions as follows:
receiving a transaction request, the transaction request for a transaction to charge a payment account managed by a payment entity;
detecting that the transaction request exceeds a transaction limit applicable to the payment account; and
transmitting a message to the payment entity to indicate that the transaction request exceeds the transaction limit.

9. The apparatus of claim 8, wherein the transaction limit is defined as a monetary amount.

10. The apparatus of claim 9, wherein the monetary amount is a cumulative amount.

11. The apparatus of claim 9, wherein the monetary amount is a single-transaction amount.

12. The apparatus of claim 8, wherein the transaction limit is defined as a number of transactions.

13. The apparatus of claim 8, wherein the transaction limit applies to all transactions that use any one of a plurality of payment tokens, all of the payment tokens corresponding to said payment account.

14. The apparatus of claim 8, wherein the processor is further operable with the program instructions to accumulate, prior to said receiving step, at least one of (a) a transaction count relevant to said transaction limit; and (b) transaction amounts relevant to said transaction limit.

15. A method comprising:
receiving a transaction request, the transaction request for a transaction to charge a payment account managed by a payment entity;
extracting first data from the transaction request;
retrieving second data, said second data indicative of a current value of a counter and/or accumulator maintained for the payment account;
retrieving third data, said third data indicative of a transaction limit applicable to the payment account; and
transmitting a message to the payment entity, the transmitted message including said first data, said second data and said third data.

16. The method of claim 15, wherein the transaction limit is defined as a monetary amount.

17. The method of claim 16, wherein the monetary amount is a cumulative amount.

18. The method of claim 16, wherein the monetary amount is a single-transaction amount.

19. The method of claim 15, wherein the transaction limit is defined as a number of transactions.

20. The method of claim 15, wherein the transaction limit applies to all transactions that use any one of a plurality of payment tokens, all of the payment tokens corresponding to said payment account.
